(19) United States
(12) Patent Application Publication
(10) Pub. No.: US 2019/0022518 A1
(43) Pub. Date: Jan. 24, 2019

(54) Chemistry Based Board/Video Game

(71) Applicants: Peter Charles Godwin, Seattle, WA (US); Jacob Andrew Godwin, Seattle, WA (US)

(72) Inventors: Peter Charles Godwin, Seattle, WA (US); Jacob Andrew Godwin, Seattle, WA (US)

(21) Appl. No.: 16/041,672

(22) Filed: Jul. 20, 2018

Related U.S. Application Data
(60) Provisional application No. 62/535,550, filed on Jul. 21, 2017.

(51) Int. Cl. A63F 3/04; A63F 13/30; G09B 23/24; A63F 9/24

(52) U.S. Cl. CPC A63F 3/0457; A63F 13/30; A63F 2003/00996; A63F 9/24; A63F 2003/0476; G09B 23/24

(57) ABSTRACT

Chemistry game systems and methods are provided. The systems and methods provide an analog and a video portion which may be employed together or separate. Characters in the game battle each other and the outcomes may be based on character statistics and or chance. When employed together the video portion may display a graphical display of an interaction that takes place between the characters in the analog game.

### CROSS REFERENCE TO RELATED APPLICATIONS

This application claims the benefit of the filing date of U.S. provisional patent application Ser. No. 62/535,550, titled “Chemistry Based Board/Video Game,” which was filed in the USPTO on Jul. 21, 2017 (the “Provisional”) and which includes the same inventors. The Provisional is hereby incorporated by reference as if fully set forth herein.

### FIELD OF THE TECHNOLOGY

One or more embodiments of the disclosed technology relate(s) generally to video games and/or board games, and more specifically but not exclusively to a combined board game and video game based on chemistry.

### BACKGROUND OF THE TECHNOLOGY

Games may be useful for entertaining people. They may also useful as teaching tools for teaching people difficult or daunting subjects without them necessarily realizing that they are being taught.

There are different types of games such as board games, card games, video games, etc. A popular type of game involves multiple characters fighting against one another, either in teams or individually. Such games may employ statistic cards, dice throws, spinners, random number generators and/or a combination of these to determine the likelihood and/or outcome of a battle. Often, after playing these types of games, the players tend to remember the statistics for the different characters.

Chemistry is a subject matter which involves memorization. However, many people find chemistry to be a daunting subject.

It would thus be advantageous to provide a game that assists in teaching chemistry in an enjoyable way.

### BRIEF SUMMARY OF THE TECHNOLOGY

Many advantages will be determined and are attained by one or more embodiments of the disclosed technology, which in a broad sense provides a combination board game and video game based around chemistry, in which players engage in character combats and learn about elements as the game progresses.

In one or more embodiments, the technology provides a combined analog and digital chemistry based game. The game includes character cards that provide attributes of a character. The character represents an element from the periodic table. At least two The analog portion of the game includes character pieces respectively associated with at least two of the character cards. The game also includes a card reader that determines the attributes of a character from a character card and applies the determined attributes to a graphical representation of the character. The game also includes a game board such that the character pieces are supported by the game board during play. The game also includes a processor based graphical interface that, in response to receiving the attributes of characters from the card reader, portrays an interaction between the two characters. The portrayed interaction represents an interaction between at least two character pieces.

In one or more embodiments, the technology provides a method for teaching chemistry. The method includes providing characters which include attributes. At least two of the characters respectively include attributes which coincide with attributes of at least two elements from a periodic table. The method also includes providing a physical gaming area for an interaction between the at least two characters. The method further includes providing an electronic gaming area for another interaction between the at least two characters. The method also includes synchronizing the interaction and another interaction such that a result of the interaction and a result of the other interaction is the same result.

In one or more embodiments, the technology provides a non-transitory computer-readable medium that includes one or more computer-executable instructions that, when executed by at least one processor of a computing device, cause the computing device to read character attributes from character attribute cards. Each of the character attribute cards is respectively associated with a separate character. The computing device is also caused to display, on a display, an interaction between images which represent at least two of the associated characters. The interaction is synchronized with a physical game which operates with the character attribute cards.

The technology will next be described in connection with certain illustrated embodiments and practices. However, it will be clear to those skilled in the art that various modifications, additions and subtractions can be made without departing from the spirit or scope of the claims.

### BRIEF DESCRIPTION OF THE DRAWINGS

For a better understanding of the technology, reference is made to the following description, taken in conjunction with the accompanying drawings, in which like reference characters refer to like parts throughout, and in which:

FIG. 1 provides a block diagram illustrating a chemistry game system in accordance with one or more embodiments of the disclosed technology;

FIGS. 2A-C provide diagrams of an exemplary analog game board and playing pieces portion of the game system of FIG. 1 in accordance with one or more embodiments of the disclosed technology;

FIG. 3 provides a block diagram of an electronic portion of the game system of FIG. 1 in accordance with one or more embodiments of the disclosed technology; and,

FIGS. 4-18 provide exemplary statistical attributes of various characters in accordance with one or more embodiments of the disclosed technology.

The technology will next be described in connection with certain illustrated embodiments and practices. However, it will be clear to those skilled in the art that various modifications, additions, and subtractions can be made without departing from the spirit or scope of the claims.

### DETAILED DESCRIPTION OF THE TECHNOLOGY

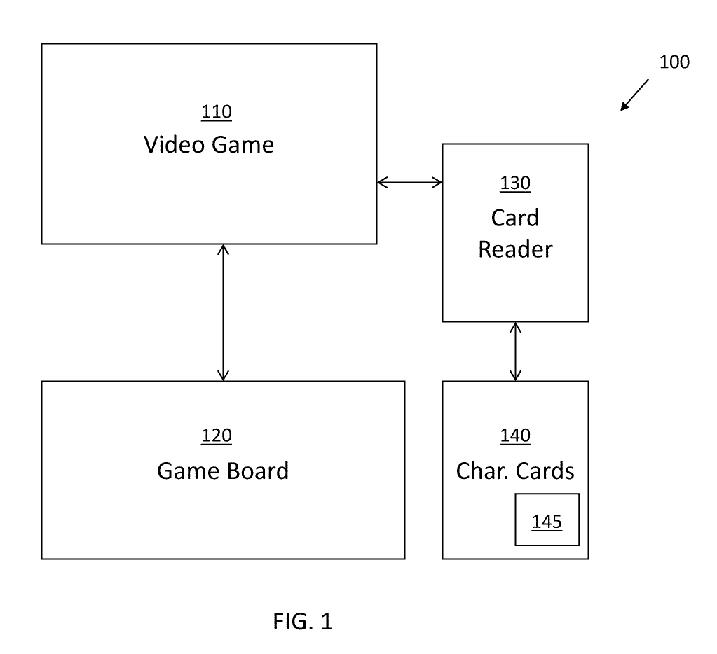

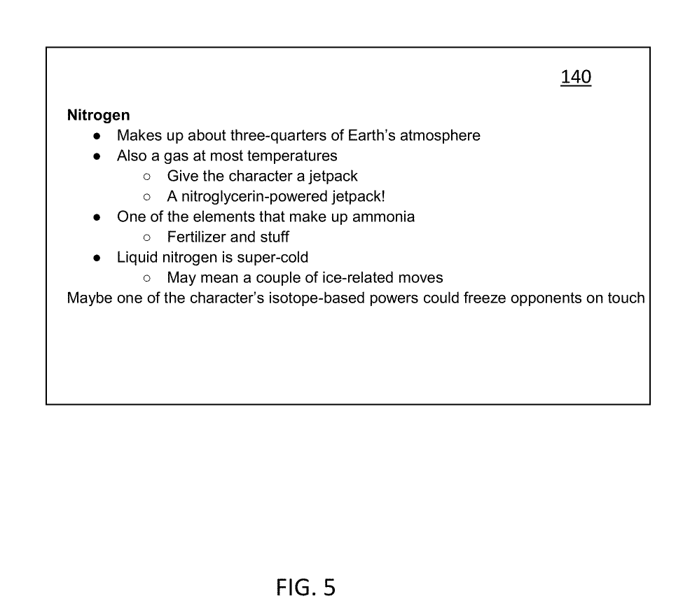

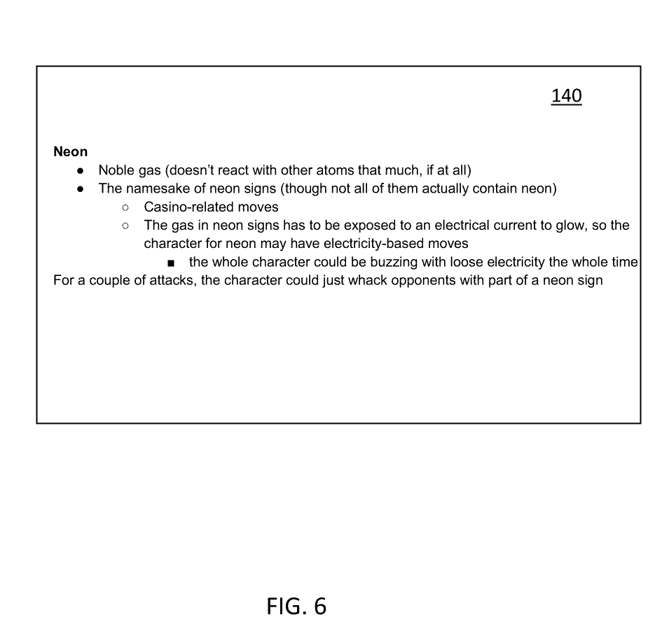

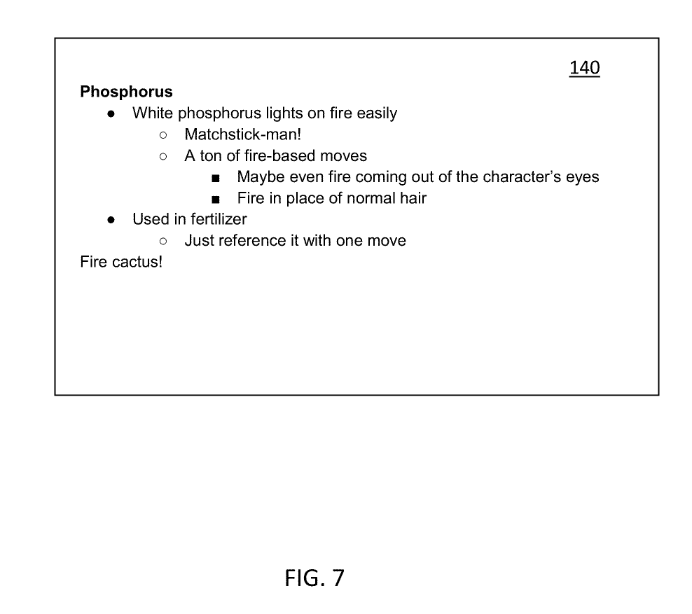

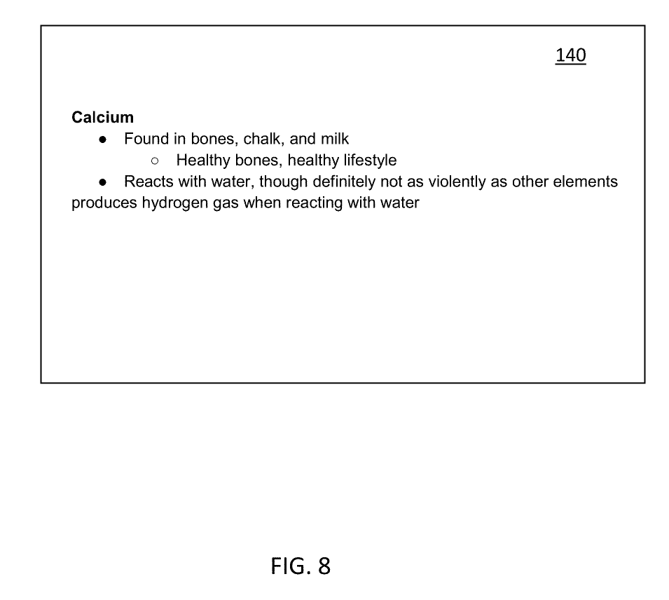

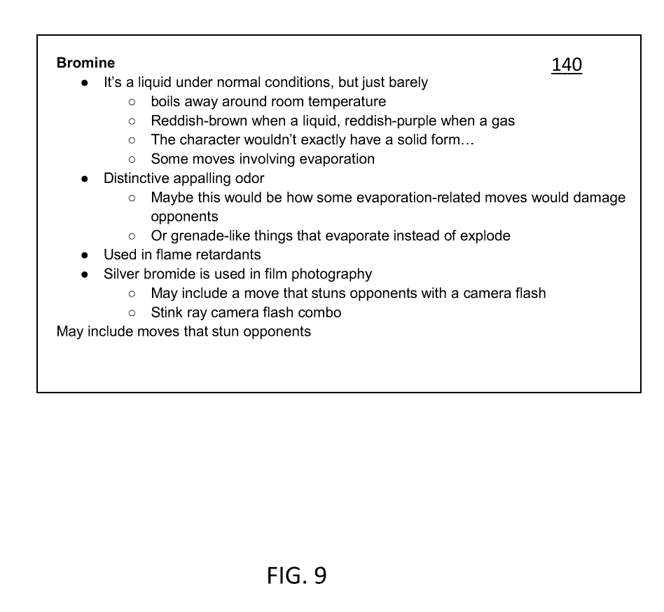

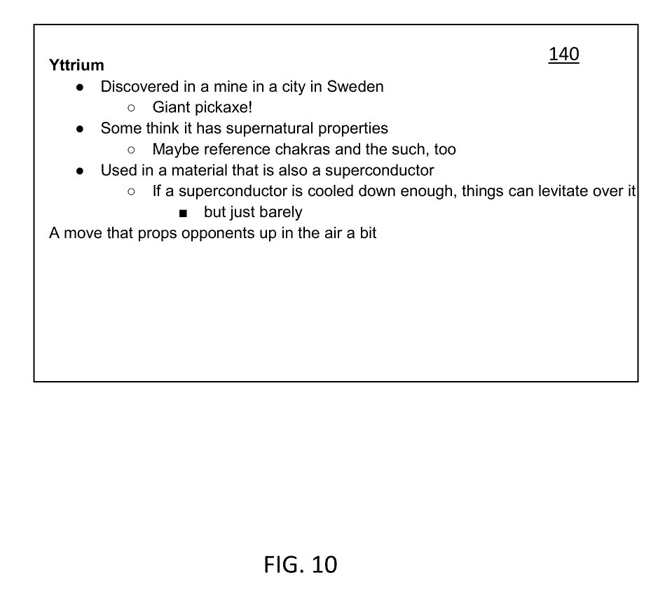

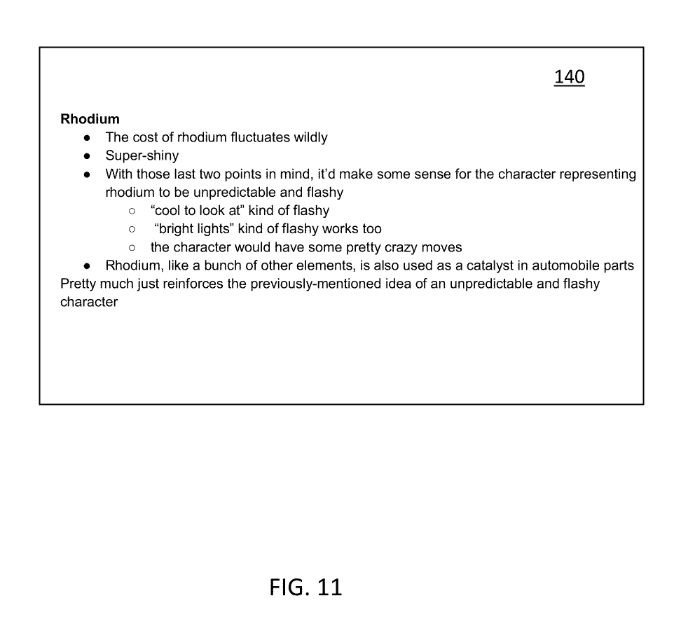

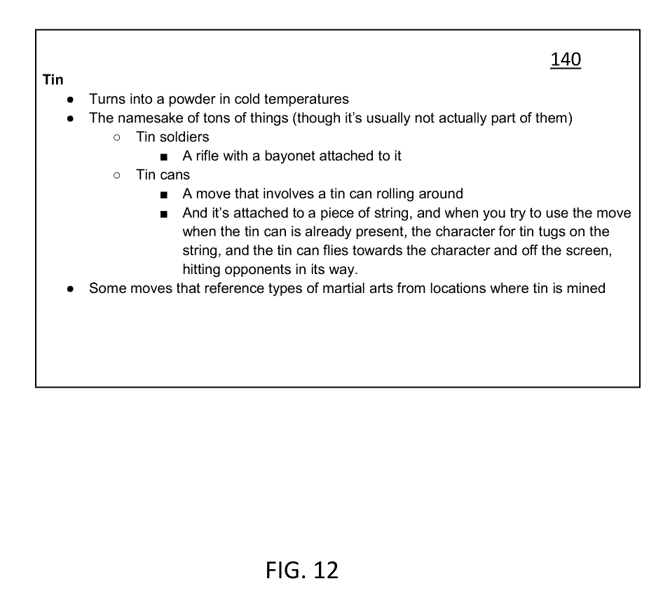

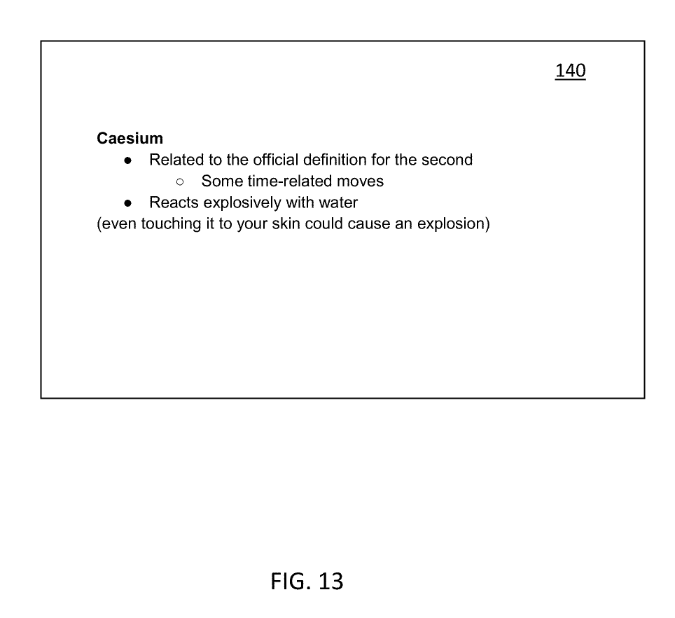

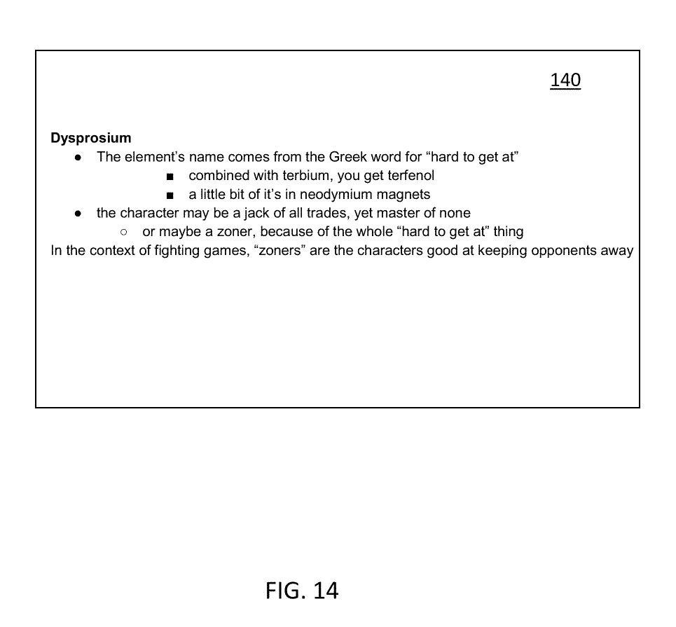

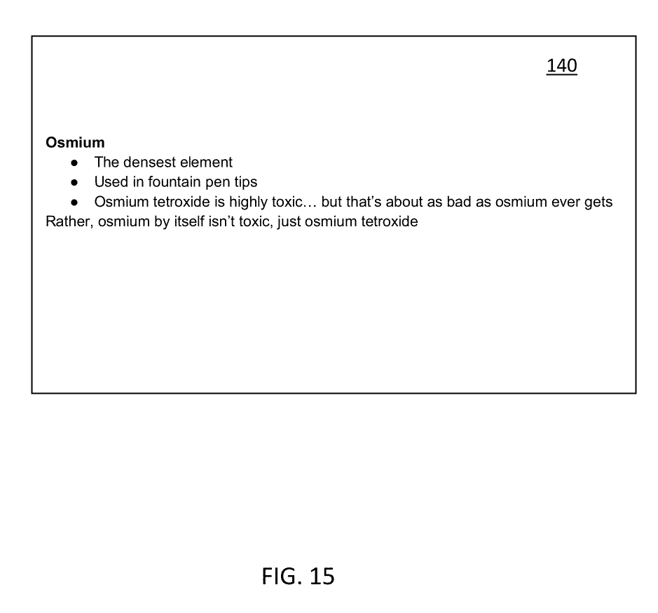

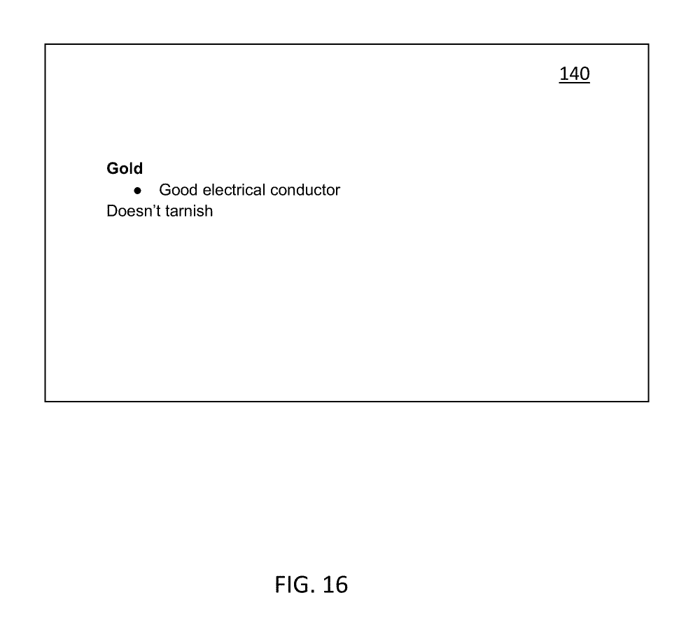

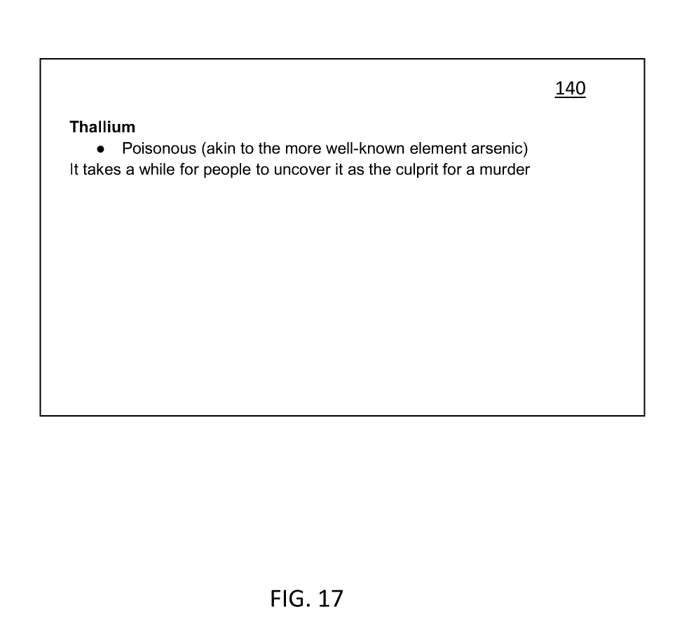

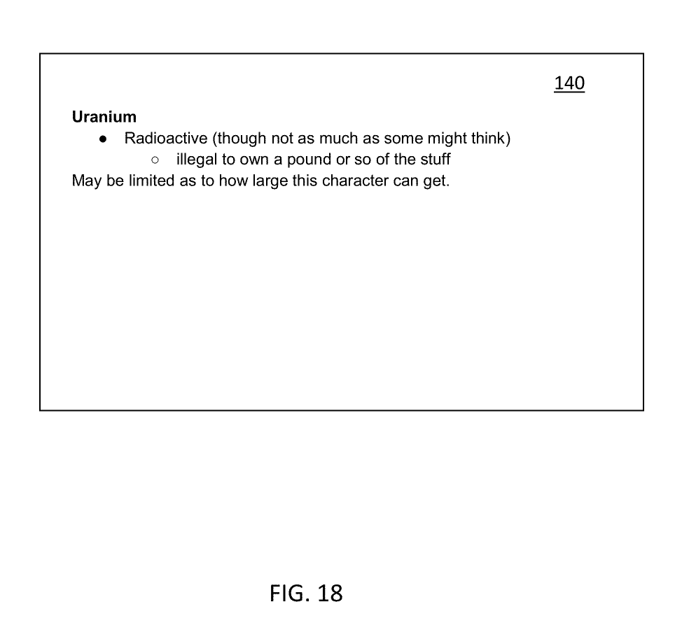

Referring to the figures in detail, there are illustrated in FIGS. 1-18 chemistry game systems and methods. The technology may provide people with an opportunity to learn the elements of the periodic table and their associated properties while playing a game. In this way, people who play the game may find that they have memorized the elements of the periodic table and their associated properties without even knowing that they were doing so. During the board game and video game flow, players may learn the symbol for the elements, the history of elements, reactions, and applications of chemistry in an historical context, as well as information about the scientists who helped advance human understanding of nature. Players may learn how elements were discovered/invented/developed, and how the periodic table developed over time.

Discussion of an embodiment, one or more embodiments, an aspect, one or more aspects, a feature, one or more features, or a configuration or one or more configurations is intended to be inclusive of both the singular and the plural depending upon which provides the broadest scope without running afoul of the existing art and any such statement is in no way intended to be limiting in nature. Technology described in relation to one or more of these terms is not necessarily limited to use in that particular embodiment, aspect, feature or configuration and may be employed with other embodiments, aspects, features and/or configurations where appropriate. Additionally, the use of the singular and the use of the plural regarding an element description is intended to be inclusive of both the singular and the plural depending upon which provides the broadest scope without running afoul of the existing art.

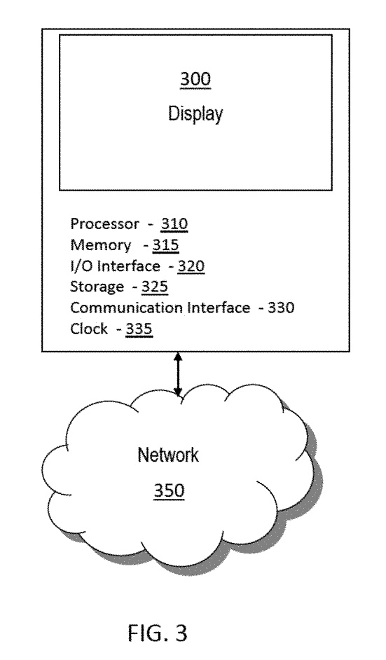

As illustrated in FIG. 3, one or more devices in the system will include, among others, common elements. These are conventional elements and thus their operation and interconnections will not be further discussed herein. Those or ordinary skill in the art are deemed to understand how common elements such as a processor 310, memory 315, storage 325, input/output (“I/O”) interface 320, communications interface 330 and clock 335 are electrically connected and how they send and/or receive messages via a bus. Those skilled in the art will recognize that the electronic portion of the game system 100 includes, among others, these elements and that the interaction between two or more of these elements is required to perform the functions of the disclosed technology.

As illustrated in FIG. 1, the technology provides a chemistry game 100 that may be played in analog mode 120 (e.g. as a board, card, spinner and/or dice game), video game mode 110 (e.g. on a gaming console, on a smart phone, on a computer, as a mobile application (app) as software stored on a CD, DVD, optical disk, or the like) or in a combination of analog 120 and video game 110 mode (e.g. the characters on the video react to moves/turns taken in the analog world, or the player moves or otherwise interacts with their analog character based on what happens in the video game portion. In video game mode 110, the characters may be controlled with a joystick, keypad or any other conventional input device 325. In analog mode 120, the characters may be moved or otherwise interacted with manually. In combination mode, a card reader 130 may be employed which interacts with a game card 140 (e.g. by reading one or more characters or codes printed on the card, matching one or more holes punched into the card, interacting with an integrated circuit (IC) chip 145 located within or otherwise associated with the card, or by reading a magnetic strip on the card) or the card 140 may be equipped with technology that allows it to interact wirelessly with a network 350 using a conventional wireless protocol. In one or more embodiments, the card reader 130 may include or be part of the video game portion 110. When playing in analog mode 120, the characteristics and/or moves associated with a character whose turn it is may be stored by the card reader 130 and/or on the card 140 for later transfer to the video game platform 110 once the video game platform 110 is restored or otherwise reconnected. The synchronization between the analog game 120 and the video game 110 may be automatic or it may require player initiation.

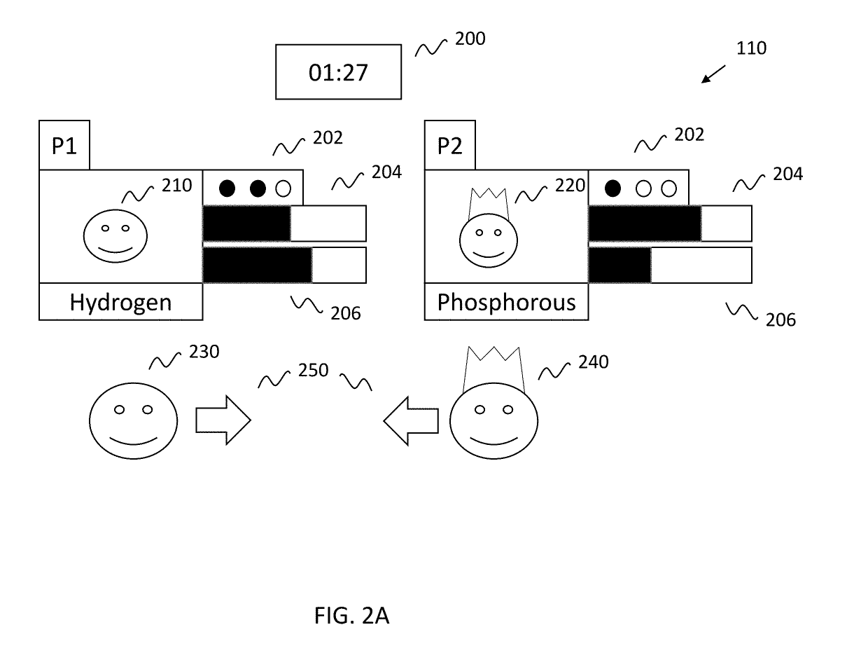

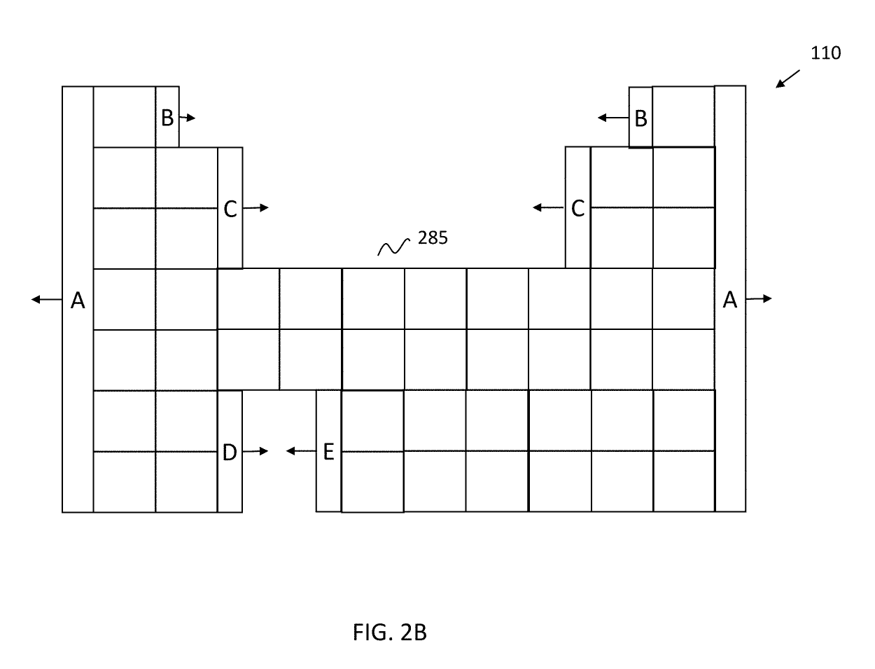

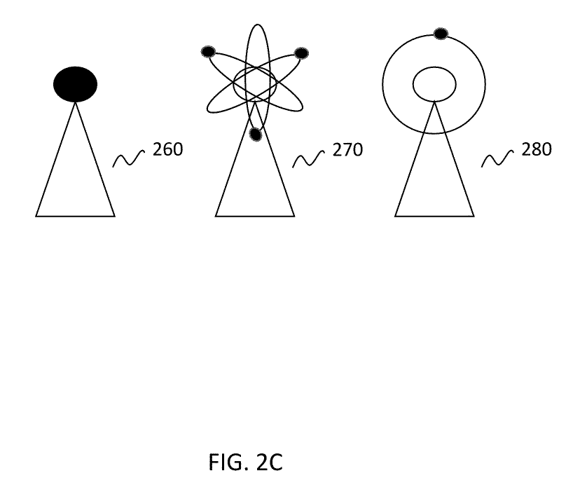

FIG. 2A illustrates an exemplary graphical display of an interaction between characters. In this non-limiting example, the character Hydrogen 230 is attacking Phosphorous 240. A timer 200 may count down the interaction, there may be a life indicator 202 for each character, a health meter 204 for each character and special abilities meter 206 for each character. When the health meter reaches empty, a character may lose a life. If a character loses 3 lives, the character loses the battle. The number of lives is a design choice. As the health of a character diminishes, that character may become more and more unstable and difficult to control. This is also a design choice. If a character fills their special ability meter, then that character may be provided with an option to utilize that special ability. This too is a design choice as is the special ability provided.

FIG. 2B illustrates an exemplary layout for the analog board portion of the game. As illustrated, the board may have warp pads A, B, C, D, E which move the characters to a distant space on the board. There are many possible configurations that may be employed for the board so long as it enables interactions between characters. FIG. 2C illustrates possible physical character pieces that may be employed with the board game of FIG. 2B.

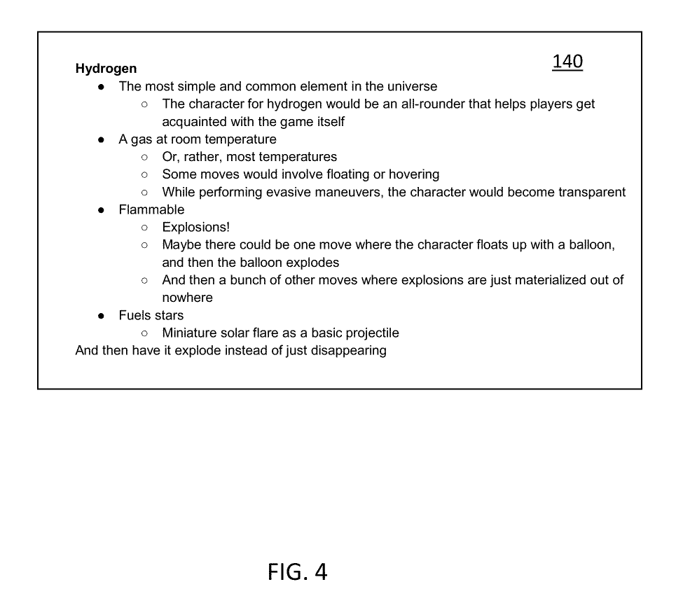

The cards 140 may be “chipped” 145 or otherwise encoded and, as illustrated in FIGS. 4-18, may contain data about one or more characters and/or about a character's special abilities. A card 140 may also or alternatively include a barcode, QR code, pattern of holes or slots, etc. (not illustrated) which may be read or otherwise interpreted by a card reader 130 to indicate the same or similar information. A card 140 may also include pictures and/or printed words/numbers to provide the player with easy access to character statistics and/or history and/or facts about the character. In one or more embodiments, a player may modify the characteristics of a character by combining cards 140, or otherwise programming the cards 140 to add or remove electrons from the element. A player may combine element cards 140 with other element cards 140 to create new cards 140 that represent molecules and compounds. Because some molecules and compounds are unstable, the data on the newly created isotope cards or molecule cards may expire back to their normal state (in the case of element cards) or dissolve and disappear (in the case of unstable compound cards) over time or after a certain number of turns. The cards 140 themselves may contain images of the player/element, basic data about the element (e.g. how they appear on the periodic table), and may be playable, tradeable and collectible on their own.

During analog play, a player may move around a board 120 and collect or lose abilities, electrons or interact with other characters or situations. Movement may be dictated by rolling one or more dice, spinning a spinner, selecting a card which instructs the player and/or having a random number generated. Alternatively, or additionally, players may arrange their cards 140 for a battle with another player or with a game character. There may be group battles, individual battles, individuals against a group and a group against an individual, and the game may be played in various modes (e.g. practice mode, against a computer character, against other players and/or with other players). In practice mode, the player may attack another player or a computer character but the results of the attack do not last (either the results do not attach at all or they are nullified once practice mode ended).

Initial playable characters may represent elements on the periodic table, while guest characters/non-elements related to chemistry may be introduced over time, including such things as molecules and viruses. Additionally, there may be only certain elements of the periodic table that may be initially playable. One or more elements/molecules/viruses may require a certain amount of play time and/or a certain level of experience to be achieved before it may be played. A character's turn may take inspiration from the properties of the element which it represents. This may include the movement of the character directly referencing one of the properties, and/or it may be turning those properties into the basis for the entire turn. For example, while a heavy metal such as lead may have high attributes for power or force of blows, it may have lower attributes for speed and agility. Thus, an attack and defense by lead may be powerful, but it may only be able to move short distances (e.g. it may only move a percentage of the number on the spinner or dice or it may use fewer dice for its movement turn and more dice for its attack or defense, or it may receive a respective preset addition or subtraction to an action). Additionally, the distance at which an element may attack (e.g. 1 square away, 2 squares away, in one of multiple directions, in multiple directions simultaneously, etc.) may be dependent upon its attributes.

In one or more embodiments, at the start of a game, a player may select between several different characters/elements and/or may select an isotope or an isomer. The properties and attacks of each character may be reflective of their respective element's/isotope's or compound's/isomer's properties. For guest or advanced characters such as compounds, these may include isomers or other chemistry-based characteristics. In battle, characters may be allowed to use powers related to the selected isotope/isomer. This feature may be always available or it may be metered (e.g. it may require a certain number of turns and/or a specific set of actions and/or a specific set of items before it becomes available and it may only be available for a limited number of turns and/or for a limited amount of time). A special power corresponding to a selected isotope/isomer may have limited availability and may be depleted after it has been used for the allotted time or number of turns. Activating this special isotope/isomer-related power may be performed in the video game platform by holding a specified button down, or each push of the button may toggle the power on and off, or it may require a specific combination of buttons.

During a battle, ions may also be employed to add/and or remove character traits and/or abilities. For example, striking an opponent with a specified power or ability might transfer electrons from one to the other or remove them from the opponent. If a particular ion-element matchup would cause instability, the affected character may become more powerful, but harder to control. If the matchup would make the element more stable, the affected character may become easier to control but weaker. Many similar interactions may take place without departing from a scope of one or more of the below claims.

As illustrated in the attached FIGS. 4-18, each card 140 may include various character attributes and potential booster and interaction properties. While only a limited number of characters are presented, and very limited characteristics and abilities are presented this is for illustrative purposes only. Any element from the periodic table may be employed as a possible character and various compounds, solutions etc. may be included as characters as well. The atomic weight or density of elements may be reflected in how much a character reacts to various attacks. Isotopes may provide special powers based off the properties of an element's different isotopes and isomers may provide special powers based off the properties of a compound's different isomers, they may be selected alongside characters, they may have limited usage. Ions may be lost or gained during an attack and may make the character more or less stable and powerful. Default abilities may be provided, a brief description of the element may be provided, possible upgrades may be provided and interactions with other elements may be provided on a character card 140. A character attribute that can be altered by an interaction with another character, compound, solution, isotope, isomer, etc. may be a design choice and may be permanently altered for the duration of the game, may be altered for a preset number of moves, number of turns, may be determined by time or a roll of the dice, spin of a spinner selection of a card, etc. Some characters may receive an attack boost/drain, defense boost/drain based on the character that it is attacking/being attacked by. A character may get a different boost/drain based on whether it is the attacker or the character being attacked.

Having thus described one or more preferred embodiments of the technology, advantages can be appreciated. Variations from the described embodiments exist without departing from the scope of the technology. Thus it is seen that chemistry game systems and methods are provided. Although embodiments have been disclosed herein in detail, this has been done for purposes of illustration only, and is not intended to be limiting with respect to the scope of the claims, which follow. In particular, it is contemplated that various substitutions, alterations, and modifications may be made without departing from the spirit and scope of the technology as defined by the claims. Other aspects, advantages, and modifications are considered within the scope of the following claims. The claims presented are representative of the technology disclosed herein. Other, unclaimed technology is also contemplated. The right to pursue such technology in later claims is hereby reserved.

Insofar as embodiments of the technology described above are implemented, at least in part, using a computer system, it will be appreciated that a computer program for implementing at least part of the described methods and/or the described systems is envisaged as an aspect of the technology. The computer system may be any suitable apparatus, system or device, electronic, optical, or a combination thereof. For example, the computer system may be a programmable data processing apparatus, a computer, a Digital Signal Processor, an optical computer or a microprocessor. The computer program may be embodied as source code and undergo compilation for implementation on a computer, or may be embodied as object code, for example. The computer system may include a non-transitory computer-readable medium including one or more computer-executable instructions that, when executed by at least one processor of a computing device, cause the computing device to perform specified operations/functions.

It is also conceivable that some or all of the functionality ascribed to the computer program or computer system aforementioned may be implemented in hardware, for example by one or more application specific integrated circuits and/or optical elements. Suitably, the computer program can be stored on a carrier medium in computer usable form, which is also envisaged as an aspect of the technology. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

It is accordingly intended that all matter contained in the above description or shown in the accompanying drawings be interpreted as illustrative rather than in a limiting sense. It is also to be understood that the following claims are intended to cover all of the generic and specific features of the technology as described herein, and all statements of the scope of the technology which, as a matter of language, might be said to fall there between.

Having described the technology, what is claimed as new and secured by Letters Patent is:

1. A combined analog and digital chemistry based game, the game comprising:
a plurality of character cards, wherein each of the plurality of character cards includes an attribute of a character; wherein the character represents an element from a periodic table;
at least two character pieces respectively associated with at least two of the character cards;
a card reader that determines the attributes of the at least two characters from the at least two character cards and applies the determined attributes to a graphical representation of the at least two characters;
a game board; wherein the at least two character pieces are supported by the game board during play of the game; and
a processor based graphical display that, in response to receiving the attributes of the at least two characters from the card reader, portrays an interaction between the at least two characters; wherein the portrayed interaction represents an interaction between the at least two character pieces.

2. The game according to claim 1 wherein the video device is synchronized to the game board.

3. The game according to claim 1 wherein the card reader includes a storage device.

4. The game according to claim 1 wherein at least one character card includes an integrated circuit (IC); wherein the integrated circuit contains data associated with the at least one character card.

5. The game according to claim 4 wherein the card reader includes circuitry that enables the card reader to read the data from the IC.

6. The game according to claim 1 further including at least two character cards that can be combined and replaced by a molecule card.

7. The game according to claim 1 wherein at least one character card provides attributes to a character related to an isotope.

8. A method for teaching chemistry, the method comprising:
providing a plurality of characters each of which includes a plurality of attributes;
wherein at least two of the characters respectively include attributes which coincide with attributes of at least two elements from a periodic table;
providing a physical gaming area for an interaction between the at least two characters;
providing an electronic gaming area for another interaction between the at least two characters; and,
synchronizing the interaction and another interaction such that a result of the interaction and a result of the other interaction is the same result.

9. The method according to claim 8 wherein the synchronization is automatic.

10. The method according to claim 8 wherein the synchronization is manually controlled.

11. The method according to claim 8 wherein the interaction on the physical gaming area occurs before the another interaction on the electronic gaming area.

12. The method according to claim 8 wherein the another interaction on the electronic gaming area occurs before the interaction on the physical gaming area.

13. The method according to claim 8 further comprising providing character cards for each of the plurality of characters and providing a card reader for synchronizing the physical gaming area with the electronic gaming area.

14. A non-transitory computer-readable medium comprising one or more computer-executable instructions that, when executed by at least one processor of a computing device, cause the computing device to:
read a plurality of character attributes respectively from a plurality of character attribute cards; wherein each of the plurality of character attribute cards is respectively associated with a separate character;
display, on a display, an interaction between a plurality of images; wherein each of the plurality of images is representative of at least one of the associated characters; and,
wherein the interaction is synchronized with a physical game which operates with the character attribute cards.

15. The non-transitory computer-readable medium according to claim 14, wherein the display is integral with the non-transitory computer-readable medium.

16. The non-transitory computer-readable medium according to claim 14, wherein the display is remote from the non-transitory computer-readable medium and the non-transitory computer-readable medium communicates with the display via a network.

17. The non-transitory computer-readable medium according to claim 14, wherein at least one of the plurality of character attributes is an attribute of an element of a periodic table.

18. The non-transitory computer-readable medium according to claim 14, wherein at least one of the plurality of character attributes is an attribute of a chemical compound.

19. The non-transitory computer-readable medium according to claim 14, wherein at least one of the plurality of character attributes is an attribute of an isotope.

20. The non-transitory computer-readable medium according to claim 14, wherein the synchronization is automated.

21. The non-transitory computer-readable medium according to claim 14, wherein the synchronization is manual.
